(19) United States
(12) Patent Application Publication
(10) Pub. No.: US 2023/0288148 A1
(43) Pub. Date: Sep. 14, 2023

(54) FLAT HEAT EXCHANGER AND MANUFACTURING METHOD TEREOF

(71) Applicant: Cooler Master Co., Ltd., Taipei City (TW)

(72) Inventors: Lei Lei LIU, Huizhou City (CN); Xiao Min ZHANG, Huizhou City (CN); Ding-Guo ZHOU, Huizhou City (CN)

(21) Appl. No.: 18/320,177

(22) Filed: May 18, 2023

Related U.S. Application Data
(62) Division of application No. 16/752,647, filed on Jan. 25, 2020.

(30) Foreign Application Priority Data
Apr. 12, 2019 (CN) 201910291824.1

(51) Int. Cl. F28F 1/02; B23K 26/21

(52) U.S. Cl. CPC F28F 1/022; B23K 26/21; B23K 2101/14; F28F 2275/061; F28F 2275/062; F28F 2275/067

(57) ABSTRACT

The disclosure provides a manufacturing method of a flat heat exchanger. The manufacturing method includes flattening a round heat pipe to a flat heat pipe, welding a first part of the flat heat pipe, and welding a second part of the flat heat pipe. After welding the second part of the flat heat pipe, the manufacturing method further includes cutting off part(s) of the first part or the second part of the flat heat pipe and trimming the flat heat pipe. Before welding the first part or the second part of the flat heat pipe, there is no pipe shrinkage process performed on the flat heat pipe.

### CROSS-REFERENCE TO RELATED APPLICATIONS

This is a divisional application of U.S. Non-Provisional application ser. No. 16/752,647, filed on Jan. 25, 2020, which claims foreign priority to China application no. 201910291824.1, filed on Apr. 12, 2019, the entire contents of each of which are fully incorporated herein by reference.

### TECHNICAL FIELD

The disclosure relates to a heat exchanger and a manufacturing method thereof, more particularly to a flat heat exchanger and a manufacturing method thereof.

### BACKGROUND

Heat pipe is hollow metal pipe and is capable of efficiently and uniformly transmitting heat. The heat pipe is used in various fields, such as aerospace technology, and even widely used in various consumer products, such as heat dissipation devices or cooler.

The heat pipe has a sealed chamber for accommodating coolant. The coolant is changeable between gas phase and liquid phase for the purpose of heat transmission. In detail, the liquid coolant in an end of the heat pipe contacting the heat source absorbs heat and will be vaporized to gas phase, the pressure in the chamber is increased to force the gas phase coolant to flow toward another end of the heat pipe. And the gas phase coolant will be condensed to liquid phase and flows back to the end that contacts the heat

In the manufacturing process of the heat pipe, first step is to fill coolant into a metal hollow pipe, and then a pipe shrinkage process is performed to seal both ends of the pipe. The pipe shrinkage process will create two tapered shape at the ends of the pipe. However, the tapered portions have no capability of heat transmission and thus resulting in two ineffective areas on the heat pipe. Also, the length of the tapered portion is proportional to the wide of the heat pipe, the longer the tapered portion, the longer time spending in the pipe shrinkage process. Therefore, it is required to solve the ineffective areas of the conventional heat pipe to obtain better heat dissipation efficiency and manufacturing efficiency.

### SUMMARY

The disclosure provides a flat heat exchanger and a manufacturing method thereof which are capable of improving the manufacturing efficiency and heat dissipation efficiency of the flat heat exchanger.

One embodiment of the disclosure provides a manufacturing method of a flat heat exchanger. The manufacturing method includes flattening a round heat pipe to a flat heat pipe, welding a first part of the flat heat pipe and welding a second part of the flat heat pipe.

Another embodiment of the disclosure provides a manufacturing method of a flat heat exchanger. The manufacturing method includes flattening a round heat pipe to a flat heat pipe, welding a first part of the flat heat pipe and welding a second part of the flat heat pipe. There is no pipe shrinkage process performed on the flat heat exchanger.

Still another embodiment of the disclosure provides a flat heat exchanger. The flat heat exchanger includes a flat pipe part, a first welded part, a second welded part and a capillary structure. The flat pipe part has a fluid channel. The first welded part and the second welded part are respectively located at two opposite ends of the flat pipe part to close two opposite ends of the fluid channel. At least part of the capillary is located within the fluid channel of the flat pipe part.

Yet another embodiment of the disclosure provides a flat heat exchanger. The flat heat exchanger includes a flat pipe part, a first welded part, a second welded part and a capillary structure. The flat pipe part has a fluid channel. The first welded part and the second welded part are respectively located at two opposite ends of the flat pipe part to respectively close two opposite ends of the fluid channel. The capillary structure is located within the flat pipe part. There is no pipe shrinkage process performed on the flat pipe part.

According to the flat heat exchanger and the manufacturing method thereof as discussed above, there is no pipe shrinkage process performed during the manufacturing process of the flat heat exchanger so that the time spending on the manufacturing method of the flat heat exchanger of the disclosure is relatively shorter than that on the method requires the pipe shrinkage process. This helps to increase the manufacturing efficiency of the flat heat exchanger, and the manufacturing efficiency is increased more significantly as the flat heat exchanger has wider width.

In addition, the flat heat exchanger is wider than the conventional flat heat pipe, such that the flat heat exchanger allows user to install a less amount of heat pipe exchanger to achieve the same or higher heat dissipation efficiency. Therefore, it can prevent the problem that the conventional flat heat pipes arranged side by side have low transmission efficiency.

Moreover, the flat heat exchanger has no tapered portion, such that there is no ineffective area in the fluid channel of the flat heat exchanger that the coolant cannot perform heat conduction, thereby increasing heat dissipation efficiency.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a flat heat exchanger according a first embodiment of the disclosure;

FIG. 2 is a cross-sectional view of the flat heat exchanger taken along line 2-2 of FIG. 1;

FIG. 3 is a top view of the flat heat exchanger in FIG. 1;

FIG. 4 is a side view of the flat heat exchanger in FIG. 1;

FIG. 5 is a top view of the flat heat exchanger in solid line and a set of conventional flat heat pipe in dash line; and

FIGS. 6 to 9 illustrate the manufacturing process of the flat heat exchanger in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

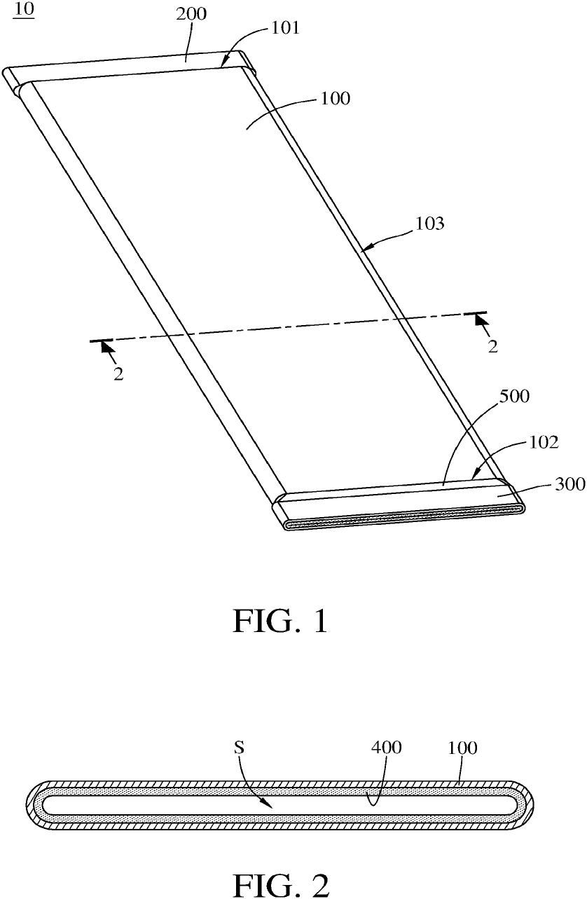

Referring to FIGS. 1 and 2, FIG. 1 is a perspective view of a flat heat exchanger 10 according a first embodiment of the disclosure, and FIG. 2 is a cross-sectional view of the flat heat exchanger 10 taken along line 2-2 of FIG. 1.

In this embodiment, the flat heat exchanger 10 is, for example, a flat heat pipe, and the flat heat exchanger 10 includes a flat pipe part 100, a first welded part 200, a second welded part 300 and a capillary structure 400.

The flat pipe part 100 has a fluid channel S. The fluid channel S is configured to accommodate a coolant (not shown). The fluid channel S can accommodate different types of the coolant according to the environment where the flat heat exchanger 10 is applied and the disclosure is not limited thereto. The first welded part 200 and the second welded part 300 are respectively located at two opposite ends of the flat pipe part 100 to close two opposite ends of the fluid channel S. The capillary structure 400 is entirely located within the fluid channel S of the flat pipe part 100, but the present disclosure is not limited thereto. In some other embodiments, the capillary structure may be partially located in the fluid channel of the flat pipe part, and the rest parts of the capillary structure may be respectively located inside the first welded part and the second welded part and respectively clamped by the first welded part and the second welded part.

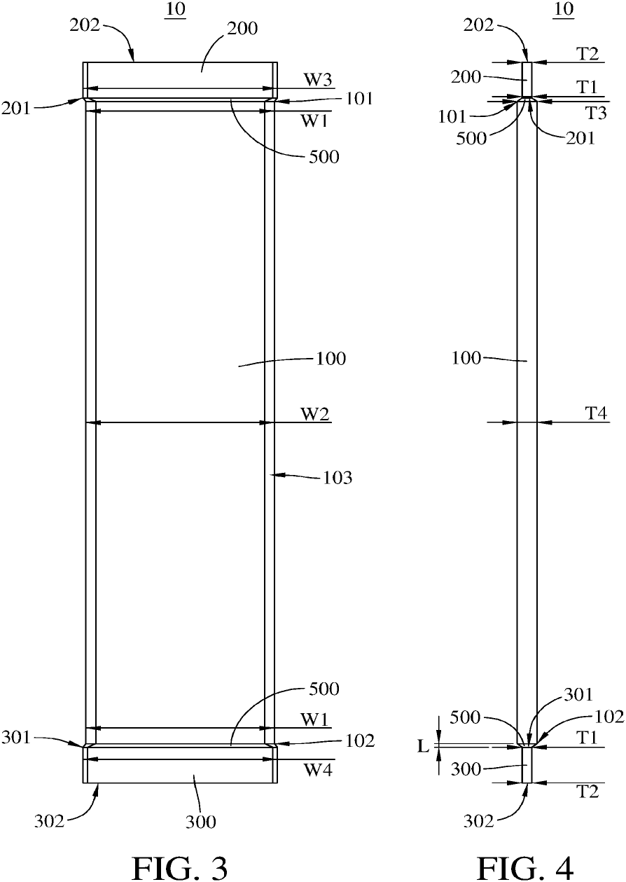

Referring to FIG. 3, FIG. 3 is a top view of the flat heat exchanger 10. The flat pipe part 100 did not undergo any deforming process. In this embodiment, the flat pipe part 100 has two opposite ends 101 and 102 in width W1 and a middle portion 103 in width W2, the first welded part 200 has a width W3, and the second welded part 200 has a width W4. In comparison, the width W1 is substantially equal to the width W2, and both the width W3 and width W4 are substantially equal to or larger than the width W2 of the middle portion 103 of the flat pipe part 100.

Referring to FIG. 4, FIG. 4 is a side view of the flat heat exchanger 10. The first welded part 200 has a first side 201 and a second side 202 opposite to each other, and the second welded part 300 has a first side 301 and a second side 302 opposite to each other. There are two deformation parts 500, one of the deformation parts 500 is connected to and located between the first side 201 and the end 101 of the flat pipe part 100, and the other deformation part 500 is connected to and located between the first side 301 and the end 102 of the flat pipe part 100. In addition, the first sides 201 and 301 substantially have the same thickness T1, the second sides 202 and 302 substantially have the same thickness T2, and the thickness T1 is substantially equal to the thickness T2.

Further, the aforementioned deforming process may also be called a “pipe shrinkage process”. The “pipe shrinkage process” is performed by a pipe shrinking machine, and the pipe shrinking machine can create two tapered portions on the ends of the pipe so as to form two pointy shapes on the ends of the pipe. Generally, the tapered portion can have a gentle or a sharp inclination depending on the actual settings of the pipe shrinking machine or other requirements. In this embodiment, the flat pipe part 100 did not undergo the pipe shrinkage process, therefore the thickness of the flat pipe part 100 is fixed. Specifically, thicknesses T3 of the ends 101 and 102 of the flat pipe part 100 are substantially equal to a thickness T4 of the middle portion 103 of the flat pipe part 100. In addition, the deformation parts 500 are caused by the manufacture process of the first welded part 200 and the second welded part 300, however, the deformation parts 500 are different from the tapered portions caused by the pipe shrinkage process. The deformation parts 500 is small enough to be negligible. As shown in FIG. 4, the deformation part 500 has a negligible amount of length L that will not negatively affect the heat dissipation efficiency of the coolant in the fluid channel S of the flat heat exchanger 10.

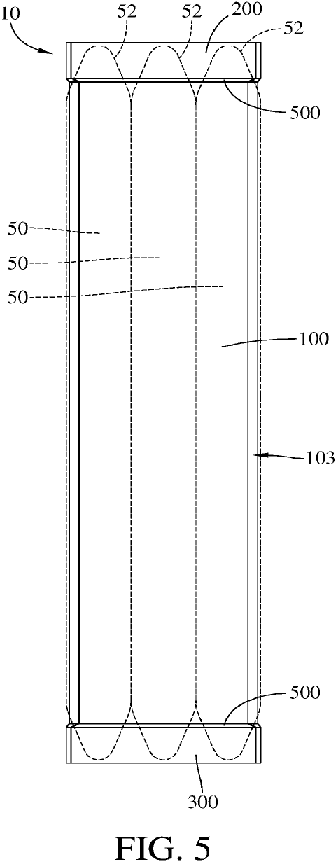

Referring to FIG. 5, FIG. 5 illustrates a top view of the flat heat exchanger 10 in solid line and a set of conventional flat heat pipes 50 in dashed line.

The flat heat exchanger 10 is approximately three times wider than the conventional flat heat pipe 50. The flat heat exchanger 10 allows user to install a less amount of heat pipe exchanger to achieve the same or higher heat dissipation efficiency. Conventionally, the conventional flat heat pipes 50 are arranged side by side so that their heat transmission has to cross the solid parts of the adjacent heat pipes, and the heat transmission efficiency is relatively low at these parts and thus decreasing the overall heat dissipation efficiency. In comparison, the single flat heat exchanger 10 does not have such problem.

In addition, the conventional flat heat pipe 50 has a tapered portion 52 on both ends caused by the pipe shrinkage process, and there is no capillary structure disposed in the tapered portions 52, such that the coolant (not shown) cannot perform heat conduction in the tapered portions 52, making the tapered portions 52 become an ineffective area. In contrast, the flat heat exchanger 10 has no tapered portions and thus having better heat dissipation efficiency than the conventional flat heat pipes 50.

Moreover, the manufacturing efficiency of the flat heat exchanger 10 is higher due to no pipe shrinkage process, and the reason will be described in later paragraphs. The following paragraphs will introduce a manufacturing method of the flat heat exchanger 10.

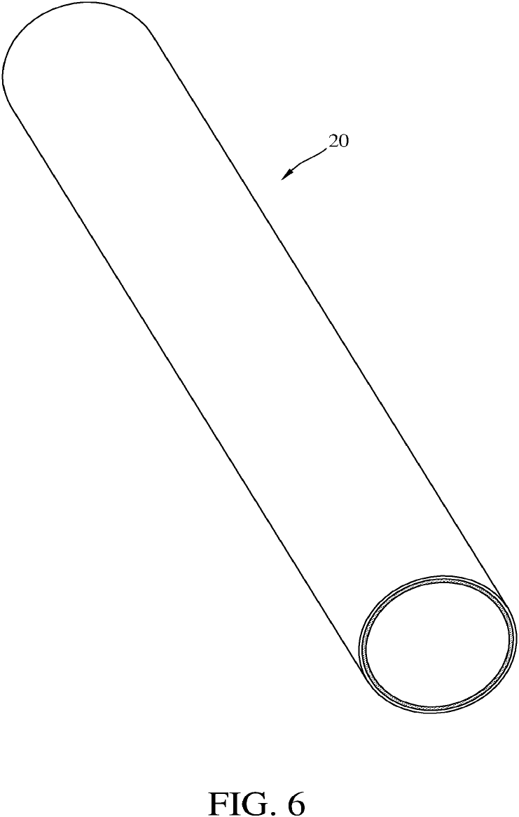

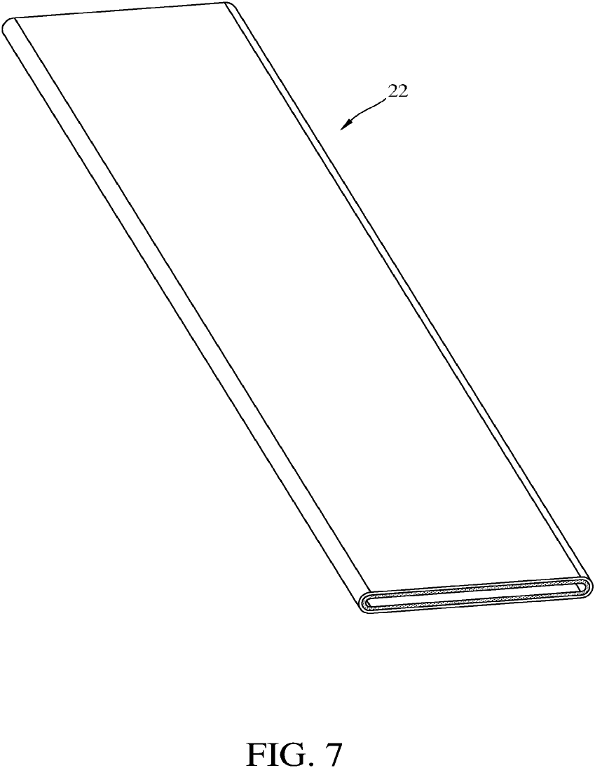

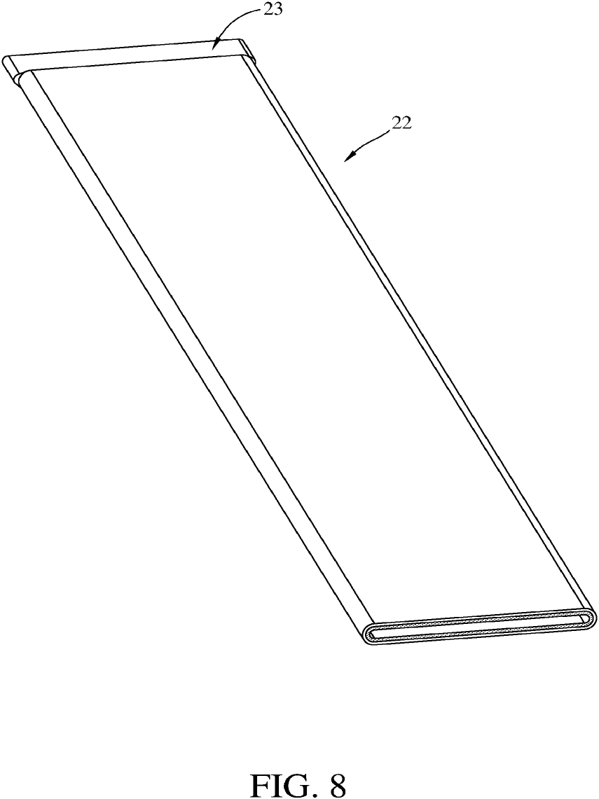

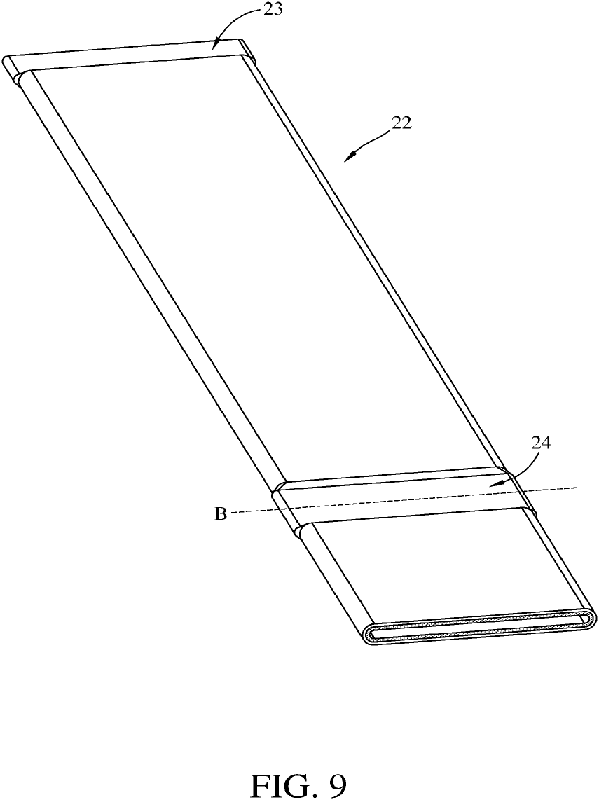

Referring to FIGS. 6 to 9, FIGS. 6 to 9 illustrate the manufacturing process of the flat heat exchanger 10. Firstly, as shown in FIG. 6, a round heat pipe 20 is provided. Then, as shown in FIG. 7, the round heat pipe 20 is flattened to a flat heat pipe 22. Then, as shown in FIGS. 8 and 9, a first part 23 and a second part 24 of the flat heat pipe 22 are further deformed by welding process. Then, the second part 24 of the flat heat pipe 22 is cut into two parts along a line B; that is, a part of the second part 24 is cut off. Lastly, the flat heat pipe 22 is trimmed to a suitable shape so as to obtain the aforementioned flat heat exchanger 10.

In this embodiment, the first part 23 and/or the second part 24 can be welded, for example, by a diffusion welding process, a pressure welding process or a laser beam welding process. In addition, during the above manufacturing process, the second part 24 is not located at the end of the flat heat pipe 22, such that the second part 24 requires the cutting process after been welded. However, if the second part is located at the end of the flat heat pipe 22, there will be no need to perform the cutting process on the second part. Furthermore, the step of trimming the flat heat pipe 22 is optional; in some other embodiments, if the appearance of the flat heat pipe meets the requirement, there is no need to trim the flat heat pipe.

From the aforementioned manufacturing method of the flat heat exchanger 10, it is noted that there is no pipe shrinkage process performed on the flat heat pipe 22 before the first part or the second part of the flat heat pipe is welded. The pipe shrinkage process is performed by a pipe shrinking machine, and the pipe shrinking machine can create two tapered portions on the ends of the pipe so as to form two pointy shapes on the ends of the pipe. Generally, the tapered portion can have a gentle or a sharp inclination depending on the actual settings of the pipe shrinking machine or other requirements. If the conventional flat heat pipe 50 is manufactured from a wider flat heat pipe, the time spending on manufacturing the conventional flat heat pipe 50 becomes longer due to the pipe shrinkage process. Therefore, the flat heat exchanger 10 did not undergo the pipe shrinkage process not only has better efficiency of heat dissipation, but also can reduce the time being manufactured.

According to the flat heat exchanger and the manufacturing method thereof as discussed above, there is no pipe shrinkage process performed during the manufacturing process of the flat heat exchanger so that the time spending on the manufacturing method of the flat heat exchanger of the disclosure is relatively shorter than that on the method requires the pipe shrinkage process. This helps to increase the manufacturing efficiency of the flat heat exchanger, and the manufacturing efficiency is increased more significantly as the flat heat exchanger has wider width.

In addition, the flat heat exchanger is wider than the conventional flat heat pipe, such that the flat heat exchanger allows user to install a less amount of heat pipe exchanger to achieve the same or higher heat dissipation efficiency. Therefore, it can prevent the problem that the conventional flat heat pipes arranged side by side have low transmission efficiency.

Moreover, the flat heat exchanger has no tapered portion, such that there is no ineffective area in the fluid channel of the flat heat exchanger that the coolant cannot perform heat conduction, thereby increasing heat dissipation efficiency.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A manufacturing method of a flat heat exchanger, comprising:
flattening a round heat pipe to a flat heat pipe;
welding a first part of the flat heat pipe; and
welding a second part of the flat heat pipe.

2. The manufacturing method of claim 1, after welding the second part of the flat heat pipe, further comprising cutting off part of the first part or the second part of the flat heat pipe.

3. The manufacturing method of claim 2, after cutting off part of the first part or the second part of the flat heat pipe, further comprising trimming the flat heat pipe.

4. The manufacturing method of claim 1, after welding the second part of the flat heat pipe, further comprising cutting off parts of the first part and the second part of the flat heat pipe.

5. The manufacturing method of claim 4, after cutting off parts of the first part and the second part of the flat heat pipe, further comprising trimming the flat heat pipe.

6. The manufacturing method of claim 1, before welding the first part or the second part of the flat heat pipe, there is no pipe shrinkage process performed on the flat heat pipe.

7. The manufacturing method of claim 1, wherein welding the first part of the flat heat pipe or welding the second part of the flat heat pipe is performed by a diffusion welding, a pressure welding or a laser beam welding.

8. A manufacturing method of a flat heat exchanger, comprising:
flattening a round heat pipe to a flat heat pipe;
welding a first part of the flat heat pipe; and
welding a second part of the flat heat pipe;
wherein there is no pipe shrinkage process performed on the flat heat exchanger.
